(19) United States
(12) Patent Application Publication
(10) Pub. No.: US 2013/0032431 A1
(43) Pub. Date: Feb. 7, 2013

(54) SYSTEM AND METHOD FOR DISSIPATION OF AN EFFECT OF A TUBE WAVE

(71) Applicants: Terry R. Bussear, Spring, TX (US); Edward J. O'Malley, Houston, TX (US)

(72) Inventors: Terry R. Bussear, Spring, TX (US); Edward J. O'Malley, Houston, TX (US)

(73) Assignee: BAKER HUGHES INCORPORATED, Houston, TX (US)

(21) Appl. No.: 13/204,474

(22) Filed: Aug. 5, 2011

(51) Int. Cl. G10K 11/162

(52) U.S. Cl. 181/196

(57) ABSTRACT

A tube wave reduction system for a borehole includes a tubular member. One or more openings in the tubular member. A dissipater in fluid communication with the one or more openings. Also included is a method for reducing an effect of a tube wave.

### BACKGROUND

In the drilling and completion arts, and indeed in all arts where flowing fluid is occasionally interrupted by a quickly closing valve, tube waves exist. Those of skill in arts associated with fluid flow are familiar with tube waves, known otherwise as “Stoneley waves” and in the vernacular as “water hammer”. These waves can range from low magnitude inconsequential forms to astoundingly high magnitude destructive forms characterized by hundreds to thousands of PSI pressure spikes.

A number of factors influence the amplitude, frequency and duration of tube waves. Some important factors are velocity and specific gravity of the moving fluid as well as the rapidity with which the flowing fluid is subjected to change in rate of flow. Each of these will affect how energetic and therefore destructive the tube wave will be. In downhole arts, in both injection and production systems, tube waves can be very significant with respect to equipment and formation face damage and therefore are a concern for operators. The art, then, would be very receptive to systems and methods capable of reducing, dampening, alleviating or eliminating tube waves.

### SUMMARY

A tube wave reduction system for a borehole includes a tubular member; one or more openings in the tubular member; and a dissipater in fluid communication with the one or more openings.

A method for reducing an effect of a tube wave includes passing at least pressure from a tube wave through one or more openings in a tubular member through which the tube wave propagates; and dissipating energy from the tube wave thereby reducing a magnitude of the tube wave.

### BRIEF DESCRIPTION OF THE DRAWINGS

Referring now to the drawings wherein like elements are numbered alike in the several Figures:

FIG. 1 is a schematic view of a tube wave dissipating system;

FIG. 2 is a schematic view of an alternate tube wave dissipating system;

FIG. 3 is a schematic view of another alternate tube wave dissipating system;

FIG. 4 is a schematic view of another alternate tube wave dissipating system;

FIG. 5 is a schematic view of another alternate tube wave dissipating system

FIG. 6 is a representative cross section of the one or more openings as disclosed herein;

FIG. 7 is an alternate representative cross section of the one or more openings as disclosed herein;

FIG. 8 is another alternate representative cross section of the one or more openings as disclosed herein;

FIG. 9 is another alternate representative cross section of the one or more openings as disclosed herein;

FIG. 10 is a view of another opening form;

FIG. 11 is a view of the embodiment of FIG. 10 90 degrees rotated;

FIG. 12 is a view of another configuration for dissipating the tube wave.

### DETAILED DESCRIPTION

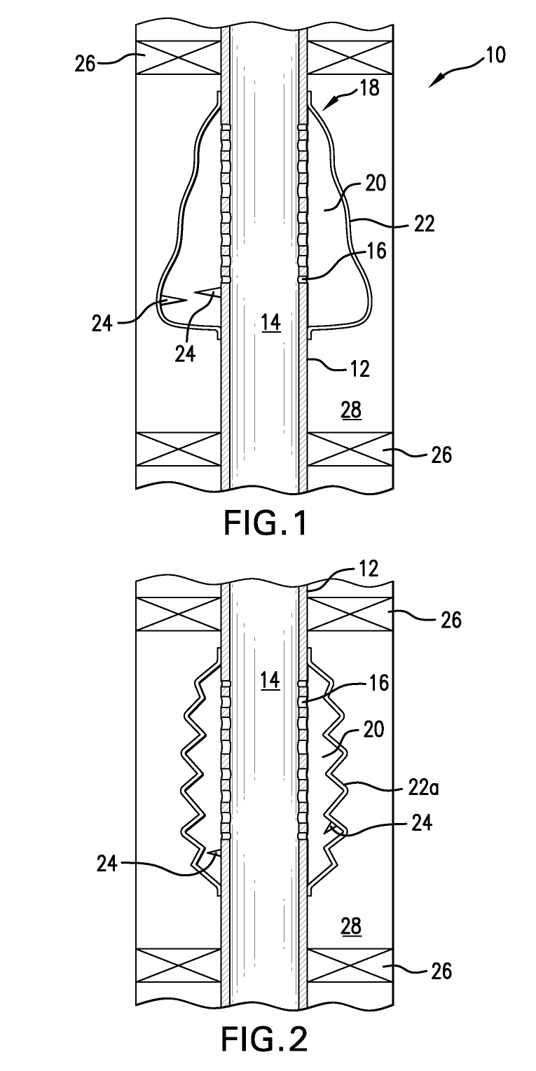

Referring to FIG. 1, a system 10 is illustrated that will reduce, mitigate, dampen, alleviate or eliminate tube waves by dissipation. The mechanisms of dissipation predominantly used in the following embodiments are friction and work. The system 10 comprises a section of tubular member 12 having an axial flow channel 14 defined by the tubular member 12 and one or more openings 16 whose axes are oriented to intersect the channel 14. The member may be a housing of its own or other stub member or may simply be a modified joint of tubing string. In one embodiment the openings will be radially oriented and in others the openings may be angularly oriented relative to the channel 14 or where more than one opening is used, combinations of radial and angular (both illustrated in FIG. 1) relative to the axial flow channel 14 may be used. The one or more openings 16 may be rounded (circular, oval, etc.) in cross section or may be slots (rectangular, square, etc.) in cross section or may be in any other geometric form for their cross sections. It is to be appreciated that the openings may be in a regular pattern, an irregular pattern, may be all of the same dimensions or may be of different dimensions from each other. Any combination of these attributes is also contemplated. Differing sizes of openings and different spacings of openings can be advantageous with respect to creating destructive interference in waveforms that are propagated through the openings.

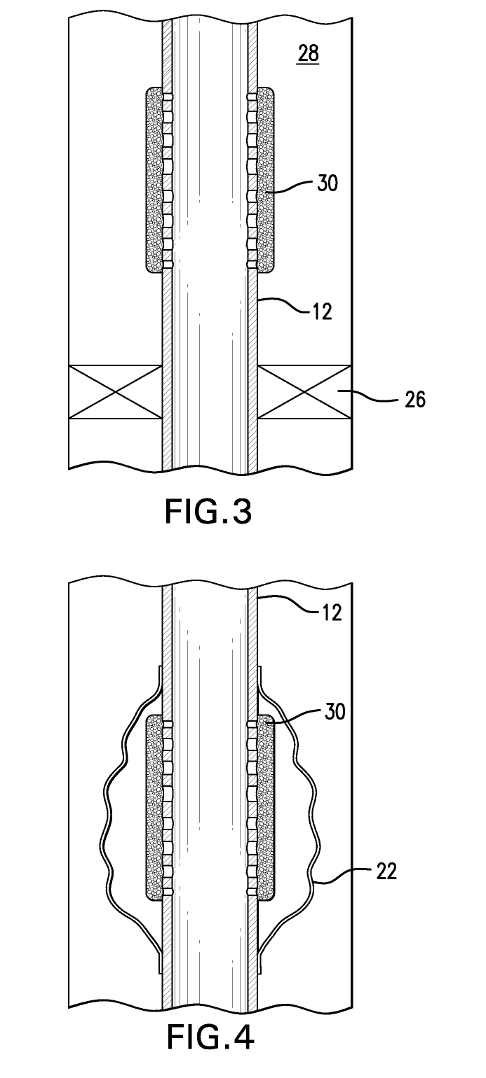

In each embodiment, the openings 16 will lead from the channel 14 to an energy dissipater 18. In the embodiments of FIGS. 1 and 2, the energy dissipater may be changeable in volume while in FIG. 3, the dissipater is a porous and permeable material such as an open cell foam. By dissipating the energy of the tube wave, the wave itself is reduced to a level where significant damage is not likely to occur to at least the component or formation portion that it is desired to protect. In some cases the wave can be completely eliminated. It will be appreciated however that complete elimination is not critical but rather that mitigation of the wave to a level where components of the downhole system and/or the formation itself would not be damaged is all that is needed for a fully successful endeavor to be realized.

Still referring to FIG. 1, one embodiment employs a configuration where the dissipater is configured as a chamber 20 in fluid connection with the one or more openings 16. The chamber can change its volume in response to a change in pressure thereby enabling the chamber to dissipate the pressure spike of a tube wave. Reduction of the energy of the tube wave is the result.

The chamber 20 is defined by a flexible material 22 connected to the tubular member 12 that may be a monomeric or polymeric material or may be another type of material such as metal providing that it has flexibility sufficient to allow the chamber it defines to expand in volume. In the case of a metal, one embodiment would be a metal bellows 22a (see FIG. 2) type configuration so that a change in internal volume of the chamber 20 is possible.

The material 22 may be elastic or inelastic. Elastic materials will dissipate the pressure spike through elastic deformation as well as through friction and destructive wave reflection interference. Where the material is not elastic it must be loose enough to generally gather about the one or more openings 16 such that it is able to change volume as noted above. In the case of the material being inelastic or substantially inelastic, the pressure spike inherent in the tube wave will simply be dissipated through the work necessary to produce movement of the inelastic material 22 itself. Without an elastic property or in cases where an elastic property exists but the change in volume of the chamber defined by the material is less than that required to elastically deform the material, the energy of the tube wave is effectively dissipated in the friction presented by the flow of fluid into the chamber and the work required to inflate the chamber 20.

In some embodiments configured generally as illustrated in FIG. 1 or 2, the material and chamber defined thereby function alone to reduce the tube wave but in other embodiments, one or more obstructions 24 such as baffles, etc. (also illustrated in FIGS. 1 and 2) can be added in the chamber area to cause fluid to travel in a tortuous path thereby causing it to lose more energy. The obstructions may be a part of the material 22 or attached to an outside of the member 12 within the area bounded by the material 22 or both. In each case, the propagating wave front from the tube wave will encounter these obstructions 24 experiencing friction and in some instances reflect a part of the waveform causing destructive wave interference. In other embodiments, we can also place such obstructions in the annulus itself. These will further dissipate energy that has moved into the annulus from the tubing.

For each of the embodiments disclosed herein an option is to include within the downhole system an isolation device such as an isolation packer or seal 26 within the annulus 28 toward which the pressure is propagated through the one or more openings 16. The placement of the isolation packer or seal 26 would be within the annulus between the component or formation the operator wants to protect from the pressure spike and the location of the one or more openings 16. It is also contemplated that two packers or seals 26 might be employed in the annulus 28, one uphole and one downhole of the one or more openings 16. It is noted that the greater the distance between packers 26 in a two packer system, the larger the pressure spike that can be dissipated. Hence, packers should be placed as far as is convenient from the openings 16 in some embodiments while still being between those openings 16 and the feature that is to be the subject of protection.

Referring to FIG. 3, the dissipater 18 is configured as porous and permeable material 30 such as an open cell foam. The dissipater is positioned against the tubular member 12 as illustrated. In this embodiment, the axial flow fluid is not physically separated from the annulus but rather is allowed to move into the annulus through the dissipater 18. The friction of the fluid moving through the dissipater effectively dissipates the energy of the pressure spike of the tube wave. In another related embodiment, the material 30 is placed within a material 22 (see FIG. 4) to provide for even more energy dissipation and additionally physical fluid segregation.

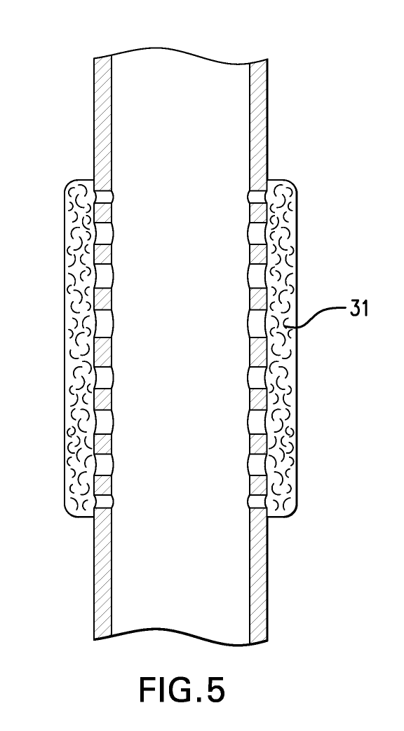

In another embodiment, referring to FIG. 5, the dissipater is a material 31 comprising a fibrous mass. The mass may be configured as a woven or nonwoven end of material that is porous and permeable as in the previous embodiment. This embodiment too may be coupled with others as disclosed herein in certain applications as desired.

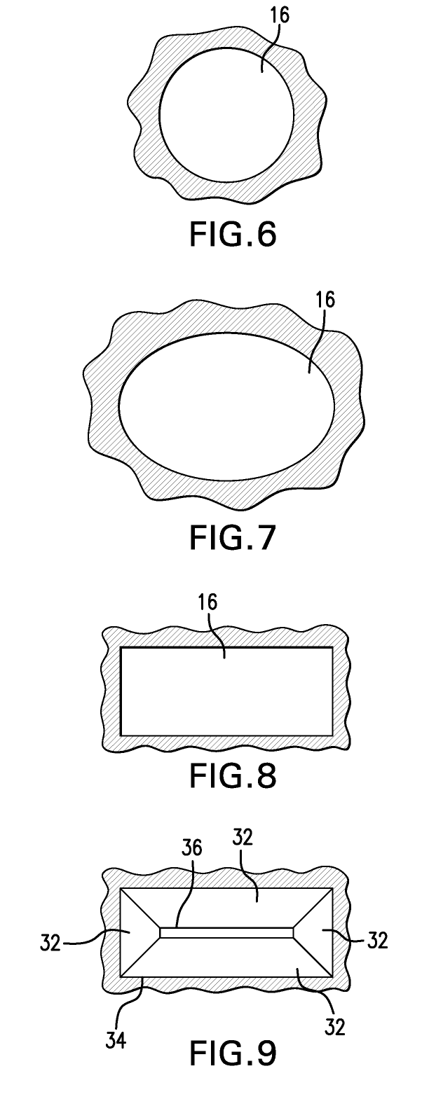

Referring to FIGS. 6-9, exemplary geometries of the one or more openings 16 are illustrated. FIG. 6 illustrates a circular geometry; FIG. 7 an oval geometry; FIG. 8 a rectangular geometry; and FIG. 9 a tapering rectangular geometry. It is stressed that these are merely examples. Further it is noted that other shapes may include lead in angles like that illustrated in FIG. 9 such as a frustoconical lead in if the cross sectional geometry is circular. Referring to FIG. 9, the lead in is identified as numeral 32, which extends from a larger side 34 of the opening 16 to a smaller other side 36 of the opening 16, which in this case is substantially a slit 36. The lead in embodiments are intended to encourage one way fluid flow.

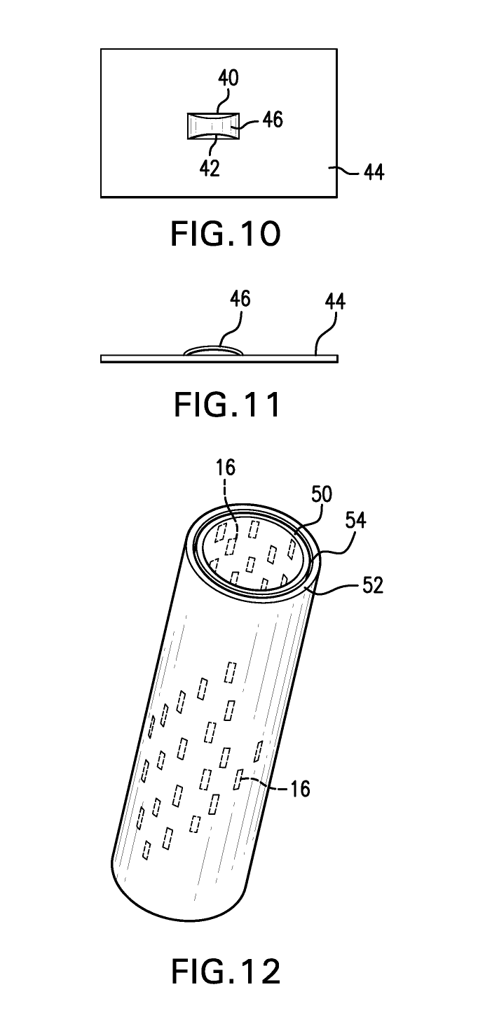

Referring now to FIGS. 10 and 11, another type of opening is illustrated that will replace or supplement the one or more openings in various iterations of the invention. In such embodiments, the opening is more readily described as an extruded/expanded slit baffle. Specifically, construction of such a port is undertaken by positioning two slits 40 and 42 through a thin sheet material 44 and then deforming the material between the two slits out of the plane of the sheet material, that portion of material becoming a baffle 46. Viewing the two figures together will make the configuration evident. It is to be understood that only one of the slit baffles 46 is illustrated for simplicity but that many more are contemplated in some arrangements. One or more may be used for particular embodiments. The opening as described assists in dissipating the tube wave both in the ways that the other embodiments herein do but also because there is a baffle 46 directly in the path of the acoustic wave attempting to radiate through the port. Once the wave does move through the opening, it will also have a difficult pathway back into the tube from the annulus due to the baffle. This arrangement can be constructed within the tubular member 12 itself or can be configured as a separate thin material disposed about the tubular member 12.

In yet another embodiment illustrated in FIG. 12, two layers of tubular material 50 and 52 are used together either as the tubular member 12 or disposed about the tubular member 12 with a small space between them forming a microannulus 54. Each of the layers includes one or more openings 16 but the openings are arranged such that they do not align between the two layers. The openings 16 may be of any of the shapes set forth herein. The arrangement complicates the tortuous path presented to the tube wave thereby dissipating more of the energy thereof.

Each of the embodiments described in this disclosure are described as singular entities but it is to be appreciated that systems can comprise multiple iterations of the described entities. Further, in systems where multiple entities are used, they can each be of the same type or they can be different types of the above described embodiments.

It is to be appreciated that configurations in accordance with the teaching herein offer no restriction to normal axial flow through the tubular member 12 nor any impediment to running of tools therethrough, each of which is advantageous to a downhole drilling and completions operator.

While one or more embodiments have been shown and described, modifications and substitutions may be made thereto without departing from the spirit and scope of the invention. Accordingly, it is to be understood that the present invention has been described by way of illustrations and not limitation.

1. A tube wave reduction system for a borehole comprising:
a tubular member;
one or more openings in the tubular member; and
a dissipater in fluid communication with the one or more openings.

2. A tube wave reduction system as claimed in claim 1 wherein the tubular member is a part of a downhole tubular string.

3. A tube wave reduction system as claimed in claim 1 wherein the dissipater is an elastic material.

4. A tube wave reduction system as claimed in claim 1 wherein the dissipater is an inelastic material.

5. A tube wave reduction system as claimed in claim 1 wherein the dissipater is loosely disposed about the one or more openings.

6. A tube wave reduction system as claimed in claim 1 wherein the dissipater defines with the tubular member a chamber.

7. A tube wave reduction system as claimed in claim 6 wherein the chamber is in fluid communication with the one or more openings.

8. A tube wave reduction system as claimed in claim 1 wherein the dissipater is a metal bellows.

9. A tube wave reduction system as claimed in claim 1 wherein one or more openings are radially oriented.

10. A tube wave reduction system as claimed in claim 1 wherein the one or more openings are angularly oriented.

11. A tube wave reduction system as claimed in claim 1 wherein the one or more openings are a combination of radially oriented and angularly oriented.

12. A tube wave reduction system as claimed in claim 1 wherein the one or more openings are of a consistent cross section.

13. A tube wave reduction system as claimed in claim 1 wherein the one or more openings are of different cross sections.

14. A tube wave reduction system as claimed in claim 1 wherein the one or more openings include a lead in.

15. A tube wave reduction system as claimed in claim 1 wherein the one or more openings are slit baffles.

16. A tube wave reduction system as claimed in claim 1 wherein the one or more openings are positioned in two radially adjacent but spaced tubular layers and the one or more openings are misaligned from one tubular layer to the other tubular layer.

17. A tube wave reduction system as claimed in claim 1 wherein the dissipater comprises a porous and permeable material.

18. A tube wave reduction system as claimed in claim 17 wherein the porous and permeable material is foam.

19. A tube wave reduction system as claimed in claim 17 wherein the porous and permeable material is a fibrous mass.

20. A tube wave reduction system as claimed in claim 17 wherein the dissipater further comprises a material radially outwardly of the porous and permeable material.

21. A method for reducing an effect of a tube wave comprising:
passing at least pressure from a tube wave through one or more openings in a tubular member through which the tube wave propagates;
dissipating energy from the tube wave thereby reducing a magnitude of the tube wave.

22. A method for reducing an effect of a tube wave as claimed in claim 21 wherein the dissipating includes expanding a material in fluid communication with the one or more openings, the material defining a chamber with the tubular member.

23. A method for reducing an effect of a tube wave as claimed in claim 21 wherein the dissipating includes flowing fluid through a porous and permeable material in fluid communication with the one or more openings.
